(19) United States
(12) Patent Application Publication
(10) Pub. No.: US 2014/0118498 A1
(43) Pub. Date: May 1, 2014

(54) WEARABLE DEVICE, DANGER WARNING SYSTEM AND METHOD

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 14/052,699

(22) Filed: Oct. 12, 2013

(30) Foreign Application Priority Data
Oct. 25, 2012 (TW) 101139587

(51) Int. Cl. G08B 21/02; H04N 13/02

(52) U.S. Cl. CPC G08B 21/02; H04N 13/0203
USPC 348/46

(57) ABSTRACT

A wearable device detects movement data of a user. A camera of the wearable device captures a three-dimensional (3D) image of an area surrounding the user. A determination is made as to whether a dangerous object appears in the area by analyzing the 3D image. If a dangerous object appears in the area, the a dangerous object appears in the area determines a distance between the user and the dangerous object, and triggers an alarm device to send out an alarm, on condition that the distance between the user and the dangerous object falls within a preset alarm range and a movement direction of the user is approaching the dangerous object.

### BACKGROUND

1. Technical Field

Embodiments of the present disclosure relate to alarm systems and methods, and more particularly to a wearable device, and a danger warning system and method.

2. Description of Related Art

People who work in construction sites are liable to be injured by sharp objects, such as nails and broken glass, for example. Discovery of the presence of sharp and dangerous objects is not always easy, and people may be injured before they realize they are in danger. Therefore, a system for detecting and warning dangers that may cause harm to people is desired.

### BRIEF DESCRIPTION OF THE DRAWINGS

FIG. 1 is a block diagram of one embodiment of function modules of a danger warning system.

FIG. 2A, FIG. 2B, and FIG. 2C illustrate embodiments of a pair of work shoes including the danger warning system as shown in FIG. 1.

FIG. 3 illustrates a worker wearing the work shoes as shown in FIG. 2A.

FIG. 4 illustrates a three-dimensional (3D) image captured by a time-of-flight (TOF) camera, which is installed in a front part of each of the pair of work shoes as shown in FIG. 2A.

FIG. 5A and FIG. 5B illustrate determining whether a dangerous object appears in the 3D image as shown in FIG. 4.

FIG. 6 is a flowchart of one embodiment of a danger warning method.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

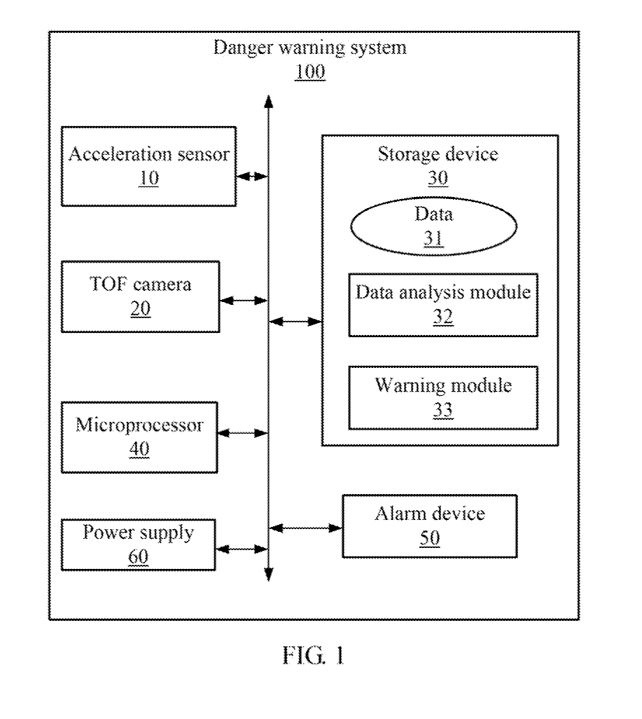

FIG. 1 is a block diagram of one embodiment of a danger warning system 100. The danger warning system 100 (hereinafter the system 100) can be applied in a wearable device, such as safety helmets, protective clothing, work shoes, and goggles, for example. In this embodiment, the system 100 includes an acceleration sensor 10, at least one camera 20, a storage device 30, a microprocessor 40, at least one alarm device 50, and a power supply 60.

The camera 20 is a time-of-flight TOF camera 20 that can measure a distance between a lens (not shown) of the TOF camera 20 and a point on an object, so that each image captured by the TOF camera 20 includes depth information, namely distance information between the TOF camera 20 and each point on objects in the image. The storage device 30 stores data 31, and a data analysis module 32 and a warning module 33, which include computerized code in the form of one or more programs.

When a user wears the wearable device, in which the system 100 is installed, and switches on the power supply 60, the acceleration sensor 10 detects movement data of the user, and stores the movement data into the storage device 30. The TOF camera 20 captures three-dimensional (3D) images of an area surrounding the user, and stores the 3D images into the storage device 30. The microprocessor 40 executes the computerized code of the data analysis module 32 and the warning module 33, to enable the data analysis module 32 to determine if a dangerous object, which may cause harm to the user, appears in the area surrounding the user by analyzing the 3D images. If a dangerous object appears in the area surrounding the user, the data analysis module 32 determines a distance between the dangerous object and the user according to the 3D images, and determines whether the distance falls within a preset alarm range and whether a movement direction of the user is approaching the dangerous object. If the distance falls within the preset alarm range and the movement direction of the user is approaching the dangerous object, the data analysis module 32 triggers the warning module 33, and the warning module 33 triggers the alarm device 50 to send out an alarm (e.g., an audible alarm), to warn the user to avoid the dangerous object.

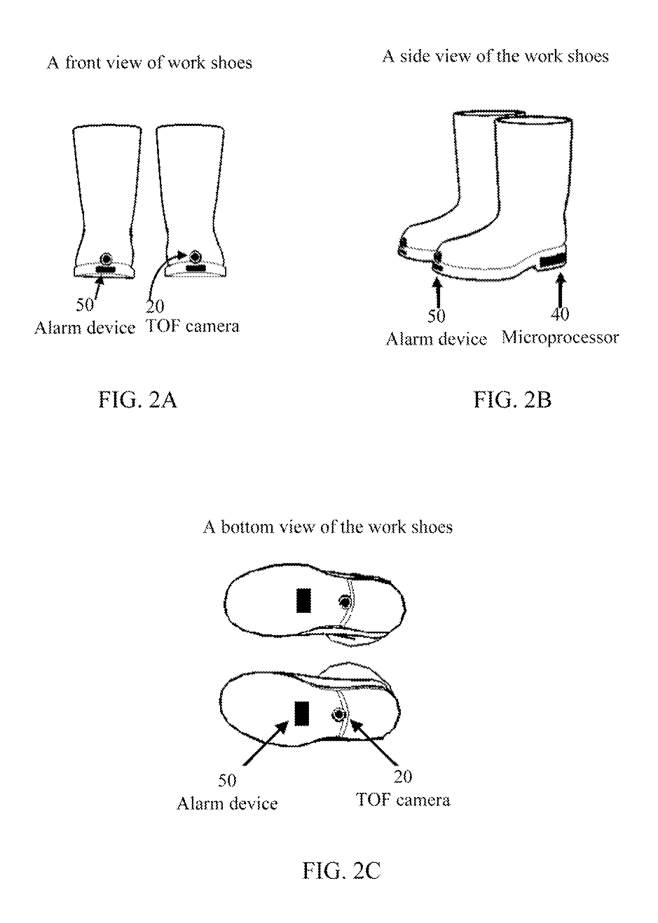

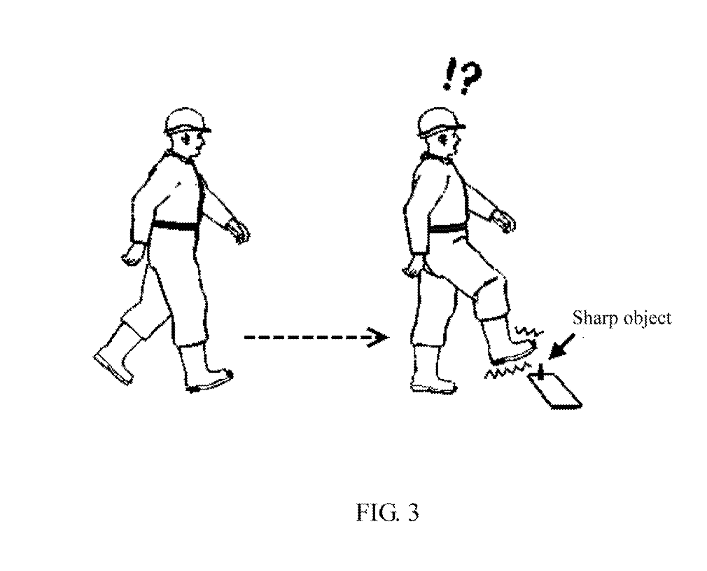

In this embodiment, the wearable device is a pair of work shoes as shown in FIG. 2A-FIG. 2C. The alarm device 50 may be a vibrator, a buzzer, a light, or other suitable warning device. The dangerous object is an object having a predefined shape or a predefined size, such as a sharp object (e.g., a nail as shown in FIG. 3). FIG. 2A is a front view of the work shoes, FIG. 2B is a side view of the work shoes, and FIG. 2C is a bottom view of the work shoes. The alarm device 50 may be installed in a toecap of each of the work shoes as shown in FIG. 2A, or installed in a sole of each of the work shoes as shown in FIG. 2C, or installed in any other appropriate part of each of the work shoes. The TOF camera 20 may be installed in the toecap (as shown in FIG. 2A), the sole (as shown in FIG. 2C), or any other appropriate part of each of the work shoes. The acceleration sensor 10, the storage device 30, the microprocessor 40, and the power supply 60 may be installed within the sole, within a heel, or in any other appropriate part of each of the work shoes. For example, as shown in FIG. 2B, the microprocessor 40 is installed in the heel of each of the work shoes.

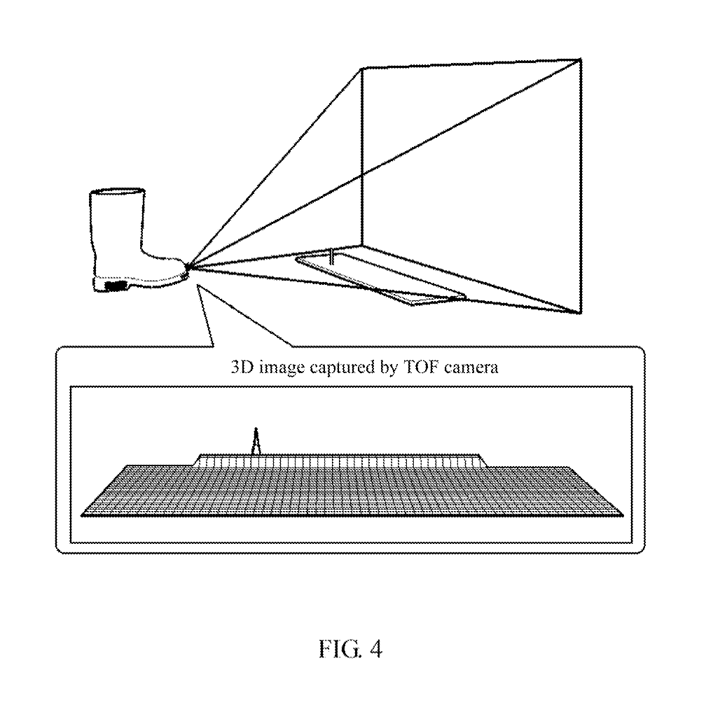

For example, supposing the TOF camera 20 of the system 100 is installed in the toecap of each of the pair of work shoes as shown in FIG. 2A. As shown in FIG. 3, when a worker wearing the pair of work shoes switches on the power supply 60, the acceleration sensor 10 detects movement data of the worker, which includes a movement direction and a movement speed, and stores the movement data into the storage device 30. The TOF camera 20 captures a 3D image (as shown in FIG. 4) in relation to the ground in front of steps/shoes of the worker, and stores the 3D image into the storage device 30.

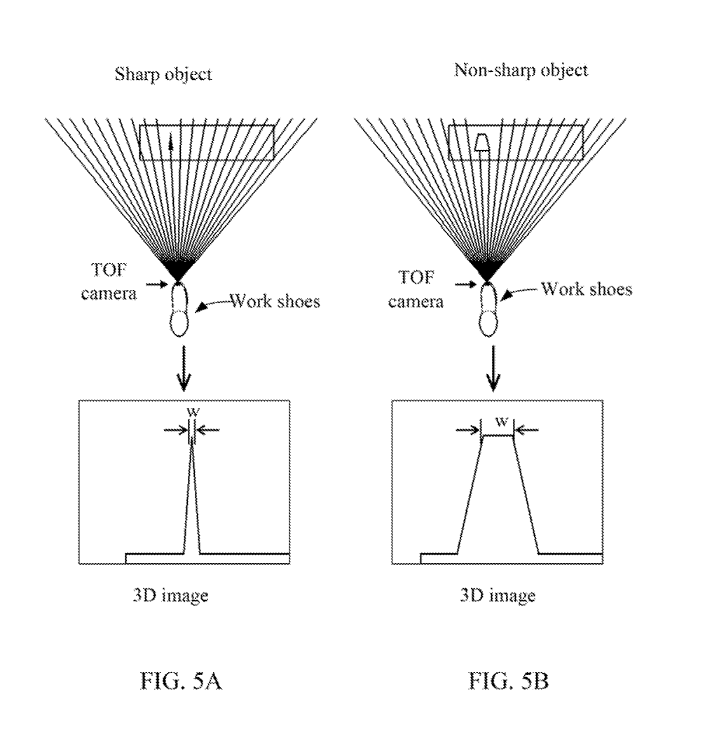

The data analysis module 32 analyzes the 3D image, determines a width of a vertex of a bulge on the ground in the 3D image (such as the width “w” of the vertex of the bulge “T” as shown in FIG. 5A and FIG. 5B). If the width of the vertex of the bulge is less than a first preset value (e.g., 0.5 cm), the data analysis module 32 determines that a sharp object is lying on the ground in front of the shoes of the worker. Then, the data analysis module 32 further determines a distance between the sharp object and the worker according to distance information of the 3D image, and determines if the worker is approaching the sharp object according to the movement direction of the worker. If the distance between the sharp object and the worker falls within the alarm range and the worker is approaching the sharp object, the alarm module 33 is activated by the data analysis module 32, and the alarm module 33 triggers the alarm device 50 to send out an alarm for warn the worker to avoid the sharp object.

The alarm module 33 may trigger the alarm device 50 to send out the alarm with different frequencies (or different amplitudes) according to the movement speed of the worker. That is, a frequency of the alarm can vary according to changes of the movement speed of the worker. For example, if the alarm device 50 is a vibrator, the greater the movement speed of the worker, the higher the frequency of the vibrations of the vibrator.

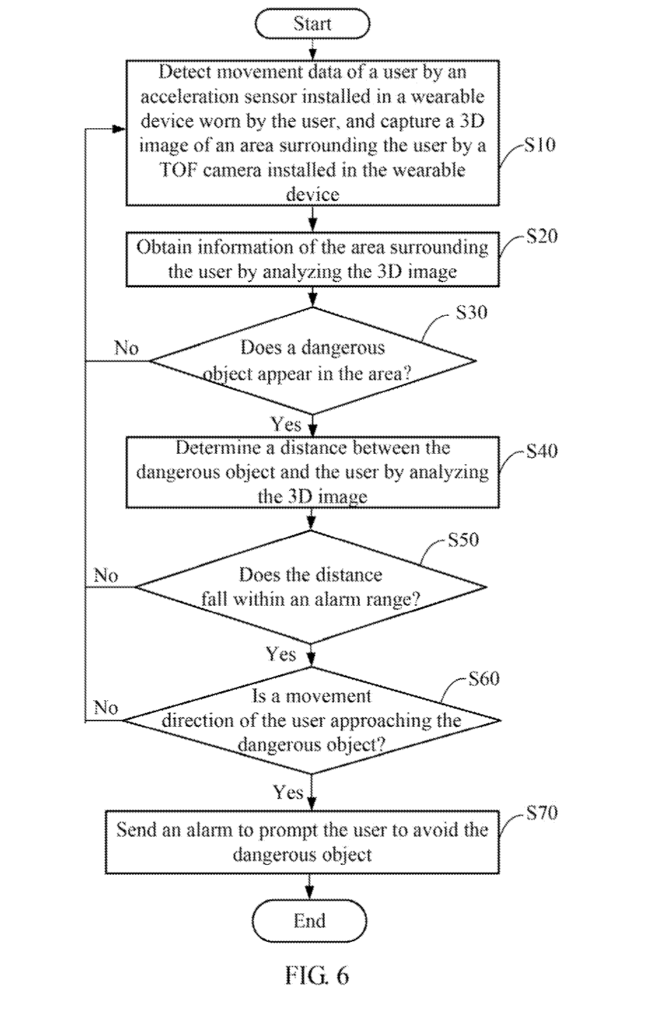

FIG. 6 is a flowchart of one embodiment of a danger warning method. Depending on the embodiment, additional steps may be added, others removed, and the ordering of the steps may be changed.

When a user wears the wearable device in which the system 100 (as shown in FIG. 3) is installed and switches on the power supply 60 of the system 100, in step S10, the acceleration sensor 10 detects movement data of the user, and stores the movement data into the storage device 30. The TOF camera 20 captures a 3D image of an area surrounding the user (as shown in FIG. 4), and stores the 3D image into the storage device 30.

In step S20, the data analysis module 32 analyzes the 3D image to obtain information of the area surrounding the user.

In step S30, the data analysis module 32 determines whether a dangerous object appears in the area according to the analysis result in step S20. For example, the dangerous object may be a sharp object as shown in FIG. 3, or any other object that has a predefined shape or size that may cause harm to the user. In one embodiment, if a width of a vertex of any bulge appeared in the 3D image (such as the width “w” of the vertex of the bulge “T” as shown in FIG. 5A and FIG. 5B) is less than a first preset value (e.g., 0.5 cm), the data analysis module 32 determines that the bulge is a sharp object and dangerous, and then the procedure goes to step S40. If no dangerous object appears in the area surrounding the user, the procedure returns to step S10.

In step S40, the data analysis module 32 determines a distance between the dangerous object and the user according to distance information of the 3D image. As mentioned above, the TOF camera 20 can measure a distance between the lens of the TOF camera and each point on an object to be captured, so that each image captured by the TOF camera 20 includes distance information between the TOF camera 20 and each point on objects in the image. In one embodiment, the distance between the dangerous object and the user may be a distance between any point on the dangerous object and the user, or may be an average value of distances between every point on the dangerous object and the user.

In step S50, the data analysis module 32 determines whether the distance between the dangerous object and the user falls within an alarm range (e.g., 50 cm). If the distance between the dangerous object and the user falls outside the alarm range, the procedure returns to step S10. Otherwise, if the distance between the dangerous object and the user falls within the alarm range, step S60 is implemented.

In step S60, the data analysis module 32 determines if the movement direction of the user is approaching the dangerous object according to the movement data detected by the acceleration sensor 10. If the movement direction of the user is deviated from the dangerous object, the procedure returns to step S10. Otherwise, step S70 is implemented.

In step S70, the alarm module 33 triggers the alarm device 50 to send out an alarm according to the movement speed of the user. For example, the greater the movement speed of the user, the more hurry the alarm.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A danger warning system being installed in a wearable device, comprising:
an acceleration sensor that detects movement data of a user who wearing the wearable device, wherein the movement data comprises a movement direction of the user;
a microprocessor:
a camera that captures a three-dimensional (3D) image of an area surrounding the user;
a storage device that stores one or more programs, when executed by the microprocessor, causing the microprocessor to;
determine whether a dangerous object appears in the area surrounding the user by analyzing the 3D image;
in response to determining that a dangerous object appears in the area surrounding the user, determine a distance between the user and the dangerous object; and
trigger an alarm device to send out an alarm in response to a determination that the distance between the user and the dangerous object falls within a preset alarm range and the movement direction is approaching the dangerous object.

2. The system as claimed in claim 1, wherein the movement data further comprises a movement spend of the user, and a frequency of the alarm varies according to changes of the movement spend.

3. The system as claimed in claim 1, wherein the distance between the user and the dangerous object is determined according to depth information of the 3D image.

4. The system as claimed in claim 3, wherein the distance between the user and the dangerous object is a distance between any point on the dangerous object and the user, or an average value of distances between multiple point on the dangerous object and the user.

5. The system as claimed in claim 1, wherein the dangerous object is an object having a predefined shape or a predefined size.

6. The system as claimed in claim 1, wherein the alarm device is a vibrator, a buzzer, or a light.

7. The system as claimed in claim 1, wherein the wearable device is selected from the group consisting of safety helmets, protective clothing, work shoes, and goggles.

8. A wearable device, comprising:
an acceleration sensor that detects movement data of a user who wearing the wearable device, wherein the movement data comprises a movement direction;
a microprocessor;
a camera that captures a three-dimensional (3D) image of an area surrounding the user;
a storage device that stores one or more programs, when executed by the microprocessor, causing the microprocessor to;
determine whether a dangerous object appears in the area surrounding the user by analyzing the 3D image;
in response to determining that a dangerous object appears in the area surrounding the user, determine a distance between the user and the dangerous object; and
trigger an alarm device to send out an alarm in response to a determination that the distance between the user and the dangerous object falls within a preset alarm range and the movement direction is approaching the dangerous object.

9. The wearable device as claimed in claim 8, wherein the movement data further comprises a movement spend of the user, and a frequency of the alarm varies according to changes of the movement spend.

10. The wearable device as claimed in claim 8, wherein the distance between the user and the dangerous object is determined according to depth information of the 3D image.

11. The wearable device as claimed in claim 10, wherein the distance between the user and the dangerous object is a distance between any point on the dangerous object and the user, or an average value of distances between multiple point on the dangerous object and the user.

12. The wearable device as claimed in claim 8, wherein the alarm device is a vibrator, a buzzer, or a light.

13. The wearable device as claimed in claim 8, wherein the dangerous object is an object having a predefined shape or a predefined size.

14. A method being executed by a microprocessor of a danger warning system installed in a wearable device, the danger warning system further comprising:
an acceleration sensor that detects movement data of a user who wearing the wearable device, wherein the movement data comprises a movement direction;
a camera that captures a three-dimensional (3D) image of an area surrounding the user; and
a storage device that stores the movement data and the 3D image; the method comprising:
determining whether a dangerous object appears in the area surrounding the user by analyzing the 3D image;
in response to determining that a dangerous object appears in the area surrounding the user, determining a distance between the user and the dangerous object; and
triggering an alarm device to send out an alarm in response to a determination that the distance between the user and the dangerous object falls within a preset alarm range and the movement direction is approaching the dangerous object.

15. The method as claimed in claim 14, wherein the movement data further comprises a movement spend of the user, and a frequency of the alarm varies according to changes of the movement spend.

16. The method as claimed in claim 14, wherein the distance between the user and the dangerous object is determined according to depth information of the 3D image.

17. The method as claimed in claim 16, wherein the distance between the user and the dangerous object is a distance between any point on the dangerous object and the user, or an average value of distances between multiple point on the dangerous object and the user.

18. The method as claimed in claim 14, wherein the dangerous object is an object having a predefined shape or a predefined size.

19. The method as claimed in claim 14, wherein the alarm device is a vibrator, a buzzer, or a light.

20. The method as claimed in claim 14, wherein the wearable device is selected from the group consisting of safety helmets, protective clothing, work shoes, and goggles.
